(19) United States
(12) Patent Application Publication
(10) Pub. No.: US 2026/0008453 A1
(43) Pub. Date: Jan. 8, 2026

(54) COOPERATIVE WILDLIFE MONITORING AND VEHICULAR-BASED HARM MITIGATION

(71) Applicant: Toyota Motor Engineering & Manufacturing North America, Inc., Plano, TX (US)

(72) Inventors: Akila C. Ganlath, Fremont, CA (US); Qi Chen, San Jose, CA (US); Shaurya Panthri, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/764,772

(22) Filed: Jul. 5, 2024

(51) Int. Cl. B60W 30/09; B60W 30/095; B60W 50/00

(52) U.S. Cl. CPC B60W 30/09; B60W 30/0953; B60W 30/0956; B60W 50/0097; B60W 2554/402; B60W 2554/4045

(57) ABSTRACT

Systems and methods described herein relate to implementing measuring battery performance during charging. In one embodiment, a method includes receiving wildlife records identifying an animal and a habitat, detecting wildlife objects relating to the animal within an area defined by the habitat, determining a likelihood of a wildlife vehicle collision based on the wildlife objects, and selecting a risk reduction strategy if the likelihood of the wildlife vehicle collision is determined to be above a threshold.

### TECHNICAL FIELD

The subject matter described herein relates, in general, to strategies for cooperative wildlife monitoring and reducing wildlife risks to vehicles or vice versa.

### BACKGROUND

Wildlife do not necessarily recognize boundaries as humans do. Instead, they may move through areas according to the existence of natural or artificial boundaries and a desire for food, cover, water, or other factors determines their activities. Inevitably, some animals will find themselves on roads where a wildlife-vehicle collision may occur. It is estimated that one to two million wildlife-vehicle collisions occur in the United States each year with an estimated annual cost of over 8.4 billion dollars. In addition, the presence of vehicles may affect animal populations or behaviors in an undesirable manner. For example, a road separating preferred food, cover, or water for a group of wildlife may result in higher levels of wildlife-vehicle collisions, thereby reducing local population densities. As another example, vehicle noises may impair a group of wildlife from enjoying their preferred food, cover, or water, such that the carrying capacity of their habitat is reduced. For some endangered animals, such as the desert tortoise, road mortality can represent a major threat to the survival of their species.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to receive wildlife records identifying an animal and a habitat, detect wildlife objects relating to the animal within an area defined by the habitat, determine a likelihood of a wildlife vehicle collision based on the wildlife objects, and select a risk reduction strategy if the likelihood of the wildlife vehicle collision is determined to be above a threshold.

In one embodiment, a non-transitory computer-readable medium including instructions that when executed by one or more processors cause the one or more processors to perform one or more functions is disclosed. The instructions include instructions to receive wildlife records identifying an animal and a habitat, detect wildlife objects relating to the animal within an area defined by the habitat, determine a likelihood of a wildlife vehicle collision based on the wildlife objects, and select a risk reduction strategy if the likelihood of the wildlife vehicle collision is determined to be above a threshold.

In one embodiment, a method is disclosed. In one embodiment, the method includes receiving wildlife records identifying an animal and a habitat, detecting wildlife objects relating to the animal within an area defined by the habitat, determining a likelihood of a wildlife vehicle collision based on the wildlife objects, and selecting a risk reduction strategy if the likelihood of the wildlife vehicle collision is determined to be above a threshold.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a wildlife management system that is associated with cooperative wildlife monitoring and reducing wildlife risks to vehicles.

FIG. 3 illustrates one embodiment of a cloud computing environment within which the systems and methods described herein may operate.

FIG. 4 illustrates one example of a global wildlife database.

FIG. 5 illustrates one example of a localized wildlife database.

FIG. 6A illustrates one example of determining a wildlife geographic area.

FIG. 6B illustrates another example of determining a wildlife geographic area.

FIG. 7 illustrates one example of a wildlife database geographic-based request.

FIG. 8 illustrates one example of a method for wildlife monitoring and management.

### DETAILED DESCRIPTION

Systems, methods, and other embodiments associated with cooperative wildlife monitoring and reducing wildlife risks to vehicles (or vice versa) are described herein. Wildlife vehicle collisions often occur because drivers have difficulty observing the presence of wildlife or indications thereof. For example, a small turtle crossing a road with potholes may be difficult to see. As another example, drivers generally do not know much about local animal behavior and how indications of wildlife (e.g., a well-rutted animal path) or obstacles affecting wildlife (e.g., a stone wall crossing a field) may be used to predict where wildlife might appear.

Accordingly, examples are described herein as to how a cooperative approach to monitoring and managing wildlife can be performed by use of wildlife records describing animals or their habitat. For example, dispersal and density data regarding an animal may be stored in a wildlife record, such that if one such animal is observed the presence of other similar animals nearby may be estimated. In addition to estimating the presence of animals, the systems and methods also allow for determining the likelihood of wildlife-vehicle collisions, the likelihood of wildlife-safety hazards presenting risks beside wildlife-vehicle collisions, and the selection of strategies to counter the likelihood of such situations or they potential harm that may arise if they are unavoidable.

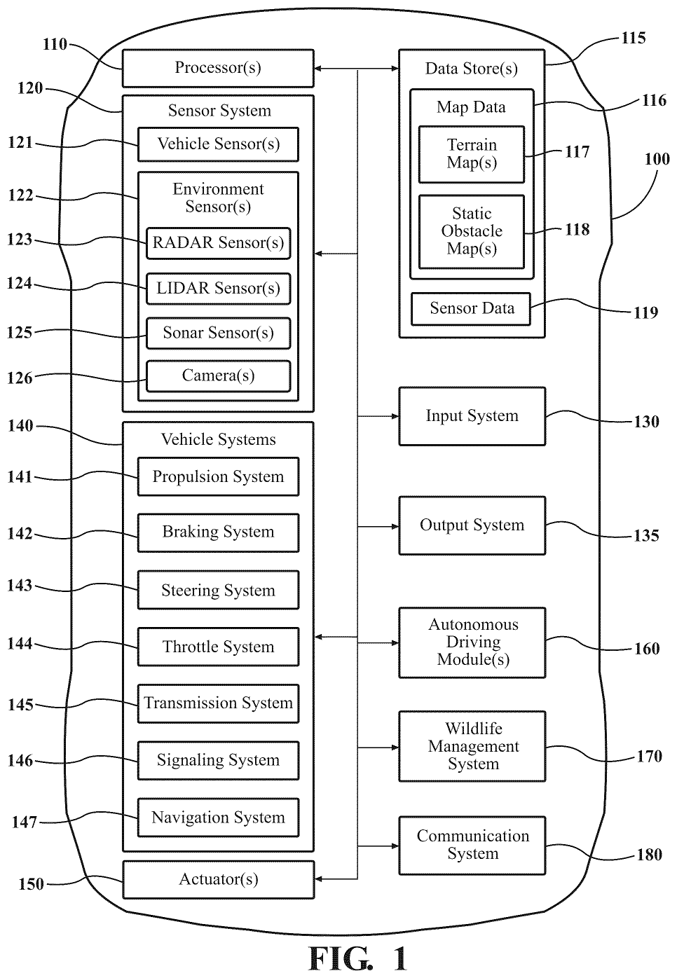

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with diagnostic charging strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

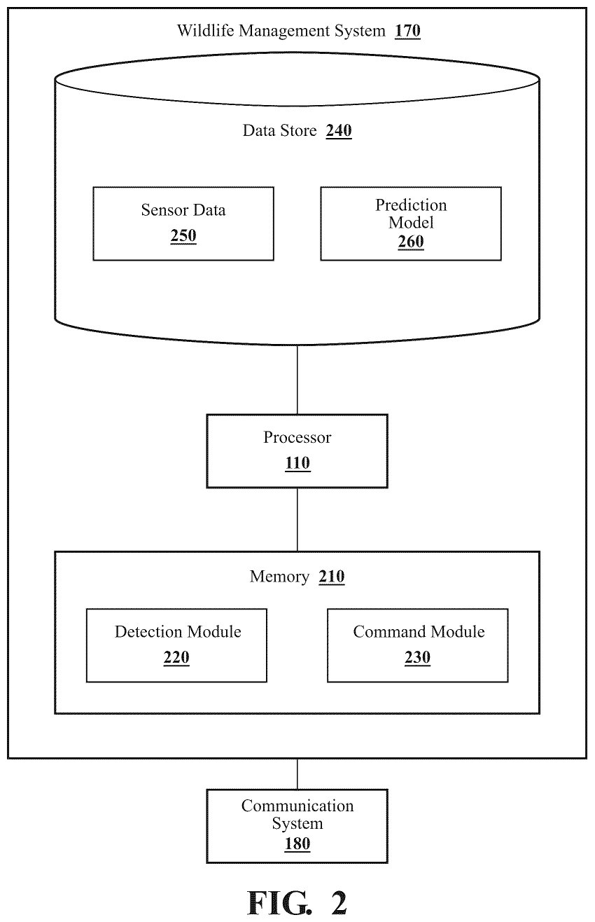

Some of the possible elements of vehicle 100 are shown in FIG. 1 and will be described along with subsequent figures. However, a description of many of the elements in FIG. 1 will be provided after the discussion of FIGS. 2-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a wildlife management system 170 that is implemented to perform methods and other functions as disclosed herein relating to cooperative wildlife monitoring and reducing wildlife risks to vehicles or vice versa. As will be discussed in greater detail subsequently, wildlife management system 170, in various embodiments, is implemented partially within vehicle 100 and as a cloud-based service. For example, in one approach, functionality associated with at least one module of wildlife management system 170 is implemented within vehicle 100 while further functionality is implemented within a cloud-based computing system.

With reference to FIG. 2, one embodiment of wildlife management system 170 of FIG. 1 is further illustrated. Wildlife management system 170 is shown as including processor(s) 110 from vehicle 100 of FIG. 1. Accordingly, processor(s) 110 may be a part of wildlife management system 170, wildlife management system 170 may include a separate processor from processor 110(s) of vehicle 100, or wildlife management system 170 may access processor 110(s) through a data bus or another communication path. In one embodiment, wildlife management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Wildlife management system 170 as illustrated in FIG. 2 is generally an abstracted form of wildlife management system 170 as may be implemented between vehicle 100 and a cloud-computing environment. Accordingly, wildlife management system 170 may be embodied at least in part within a cloud-computing environment to perform the methods described herein.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allows for the detection of wildlife objects. For example, wildlife objects may be comprised of any sensor data 250 that may be relevant to the determination of animal presence or behavior, such as observations of animals through visual or audio sensors, detection of food, cover, or habitat, or other factors as described herein.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, wildlife management system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to obtain battery measurements as described herein. In some embodiments, detection module 220 may receive and store battery measurements.

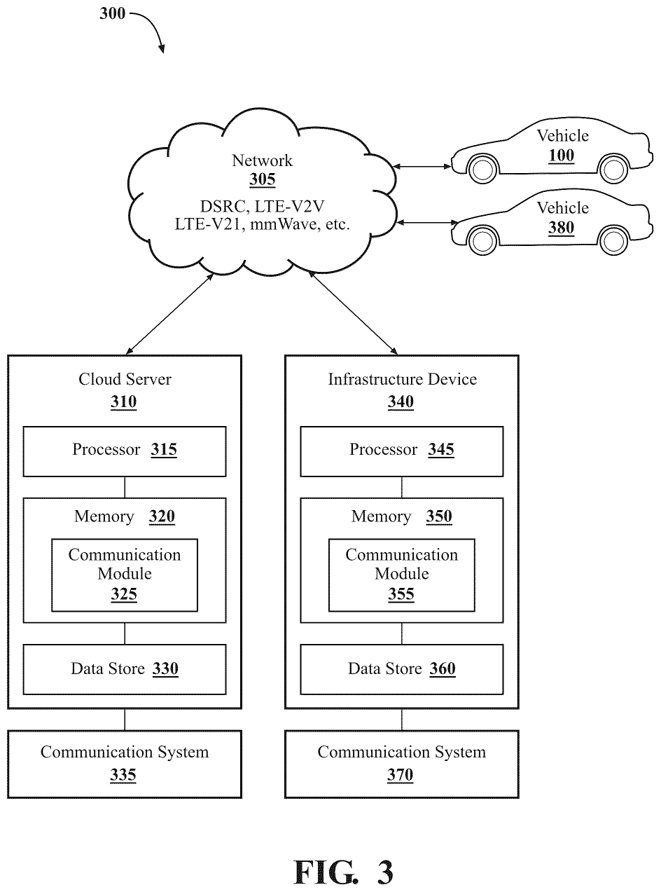

In one embodiment, command module 230 generally includes instructions that function to control the processor(s) 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of wildlife management system 170 through network 305 via communication unit 335. In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of wildlife management system 170 through network 305 via communication unit 370. In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, wildlife management system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

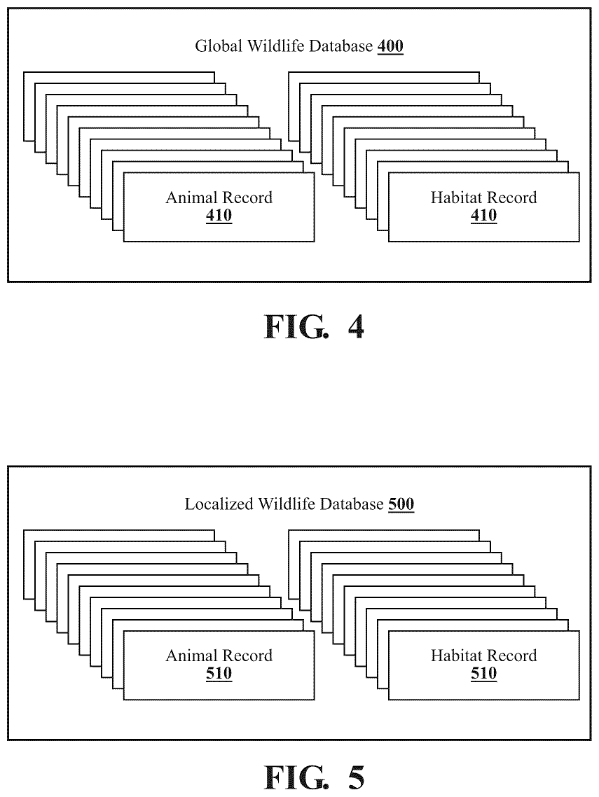

With respect to FIG. 4, an example of a global wildlife database 400 is shown. Global wildlife database 400 may be a general repository of wildlife information that resides for example within cloud-computing environment 300. For any animal of interest, an animal record 410 may be generated and stored to describe various characteristics of an animal group composed of such animals (e.g., species, subspecies, wolfpack #3) as described below. In addition, for any habitat of interest, a habitat record 420 may be generated and stored to describe various characteristics of an animal habitat by type or a specific area (e.g., temperate prairie, Yosemite National Park, Willow Springs woods) as described below.

Animal record 410 may contain, for example, entries for population dynamics such as birth rate, death rate, population size, age ratio, etc.; entries for habitat needs, such as preferences with respect to food, cover, water, or other factors for such animals to maintain a presence within a habitat; entries for habitat statistics, such as models or measures describing the expected or actual dispersal and density of an animal group within a habitat; entries for animal behavior, such as feeding behavior, foraging strategies, hunting strategies, nesting behavior, boundary encounter behaviors, reproductive strategies, migratory behavior, mating behavior, parental care behaviors, movement patterns, home range sizes, etc.; entries for animal sensitivity describing relationships to other animal groups, such as symbiotic or competitive factors that may affect animal presence or activity (e.g., predator/prey dynamics, resource generation/competition); environmental interactions, such as an animal's behavioral changes in response to weather conditions, temperature(s), air quality, etc.; entries for models or statistical measures for predicting animal presence or behavior as described herein; and so on.

Habitat record 420 may contain, for example, entries for habitat resources, such as the availability (or lack thereof) of various types of food, cover, or other factors that may be relevant to whether an animal can maintain a presence within the habitat; entries for carrying capacity, such as the carrying capacity for deer, rabbit, wolves, etc.; entries for geographical conditions, such as the location of food, water, cover, or other factors, including the presence of natural or artificial boundaries that may affect animal behavior; entries for reducing factors that may temporarily or permanently suppress the availability of habitat resources or otherwise affect a habitat's carrying capacity for one or more animal groups (e.g., new disease, pollution, severe weather, social unrest, climate change); entries for environmental conditions such as weather phenomena, water temperature, ground temperature, wind speed, air quality, etc.; and entries for models or statistical measures for predicting animal presence or behavior within the habitat as described herein; and so on.

With respect to FIG. 5, an example of a localized wildlife database 500 is shown. Localized wildlife database 500 may contain animal records 510 and habitat records 520. Animal record 510 may contain the same information as animal record 410, a portion thereof, additional details, or a combination thereof. Habitat record 520 may contain the same information as habitat record 420, a portion thereof, additional details, or a combination thereof. In some embodiments, localized wildlife database 500 may primarily contain information relating to specific habits, such as habitats along or near an expected route of vehicle 100. In some embodiments, localized wildlife database 500 may contain information that may be analyzed locally but not typically uploaded to global wildlife database 400, such as census data (e.g., droppings, tracks, vocalizations) that may be recorded by vehicle 100 for estimating a population density.

While examples below are given with respect to a global wildlife database 400, which may be stored within cloud-computing environment 300, and a localized wildlife database 500, which may be stored in vehicle 100, it should be understood that other database arrangements may also be used to store one or more wildlife databases across vehicle 100, other vehicles in communication with vehicle 100 or cloud-computing environment 300, cloud-computing environment 300, etc. In addition, while examples herein are given with respect to animal records and habitat records, animal records and habitat records may be merged together, placed within each other, cross-linked, and so on with each other in a database. In addition, animal records and habitat records collectively may be described as wildlife records.

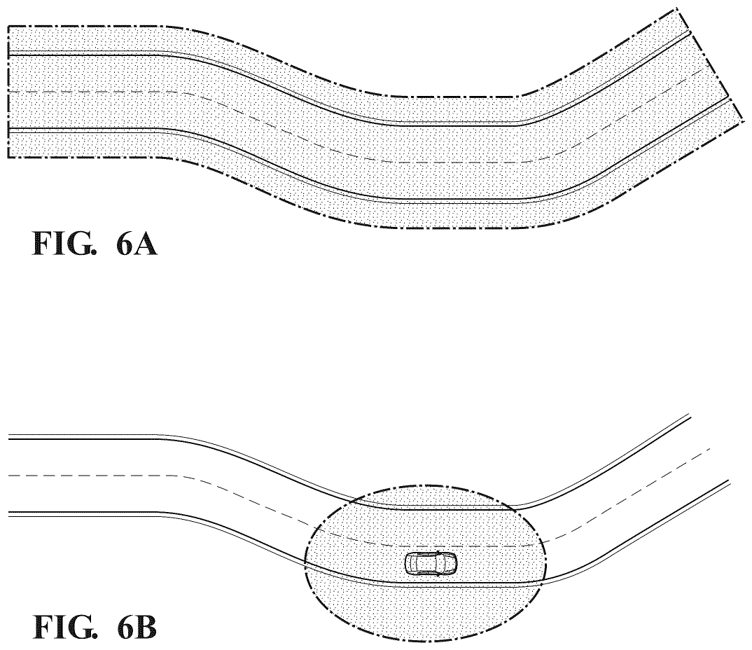

In some embodiments, command module 230 may determine a wildlife geographic area in relation to vehicle 100. For example, as shown in FIG. 6A a vehicle operator may have entered a route into vehicle 100's navigation system, which may cause command module 230 to determine a wildlife geographic area in accordance with the route(s) the vehicle operator may take (e.g., the wildlife geographic area encompasses any area within 100 feet of the navigation route selected by the vehicle operator). As another example, command module 230 may determine a wildlife geographic area based on the range in which one or more sensors of vehicle 100 can reliably detect wildlife objects as shown in FIG. 6B.

In some embodiments, command module 230 may dynamically determine or adjust a wildlife geographic area. For example, command module 230 may adjust the wildlife geographic area so that it always encompasses an area around vehicle 100 as it moves (e.g., any area within 200 feet of vehicle 100, adding or removing areas as transit occurs). As another example, command module 230 may adjust the wildlife geographic area due to environmental conditions that impair sensor range (e.g., reduce geographical wildlife area by 50% due to fog).

In some embodiments, the wildlife geographic area can also be defined by particular points within an area. For example, a wildlife geographic area may be defined by a point associated with intersections, rest stops, homes, bodies of water, and so on. Such an approach may be advantageous where only certain areas are of interest with respect to wildlife monitoring or other strategies described herein. For example, a first wildlife geographic area may be defined in relation to animals presenting a risk in terms of vehicle collisions (e.g., an area around the route of vehicle 100), and a second geographic area may be defined in relation to animals presenting a risk in terms of a wildlife safety hazard to passengers getting on or off vehicle 100 (e.g., bus station locations visited by vehicle 100).

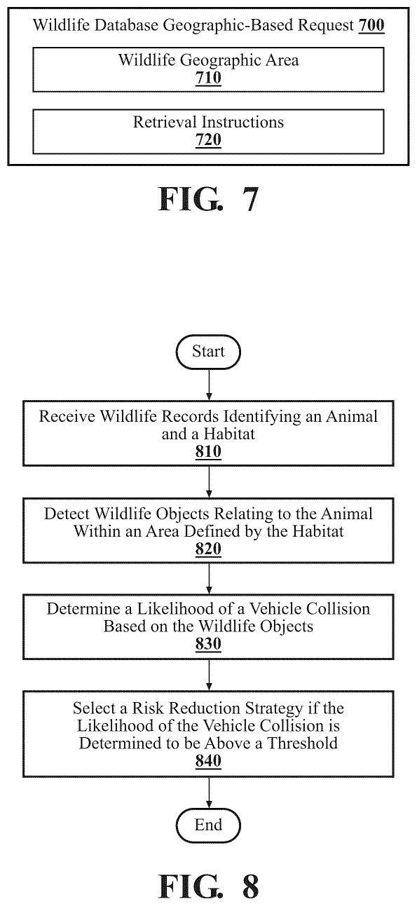

In some embodiments, command module 230 may send wildlife database geographic-based request 700 based on a wildlife geographic area as shown in FIG. 7. For example, command module 230 after determining a route and an associated wildlife geographic area (e.g., area within 100 ft of selected route for vehicle 100) may send wildlife database geographic-based request 700 that contains wildlife geographic area 710, such as to a global wildlife database 400 maintained within cloud-computing environment 300. In some embodiments, wildlife database geographic-based request 700 may also contain retrieval instructions 720 for retrieving animal records, habitat records, or both based on wildlife database geographic-based request 700. For example, such retrieval instructions 720 may include instructions for performing a search for animal records and habitat records based on wildlife geographic area 710 and sending any animal records or habitat records found to vehicle 100.

In some embodiments, command module 230 may receive a wildlife database geographic-based request based on a wildlife geographic area. For example, command module 230 may receive wildlife database geographic-based request 700 that contains wildlife geographic area 710 in which vehicle 100 has travelled through. Upon receiving wildlife database geographic-based request 700, command module 230 may perform a search for any habitat records that relate to wildlife geographic area 710 (e.g., any habitats that may exist within the wildlife geographic area such as by type or location).

Command module 230 may also perform a search for any animal records that relate to wildlife geographic area 710 (e.g., animal records associated with a particular habitat within the geographic area, animal records that were adjusted due to travelling through a habitat area within the geographic area). Once command module 230 has completed a search for animal records, habitat records, or a combination thereof, it may send such records or a portion of the data therein to the source of the wildlife database geographic-based request (e.g., a global wildlife database 400 within cloud-computing environment 300).

Upon receiving animal records, habitat records, or both, command module 230 may initialize wildlife management system 170 to perform animal monitoring. For example, based on a habitat record, command module 230 may instruct detection module 220 on how to detect a wildlife object, such as particular types of food, water, cover, artificial and natural boundaries, and so on. For example, an animal record or habitat record may contain a machine learning model configured to analyze sensor data for the presence of wildlife objects, which command module 230 may instruct detection module 220 to apply to sensor data 250. As another example, an animal or habitat record may have training data (e.g., images of animals) that command module 230 that is used to train a model maintained by detection module 220 (e.g., based on instructions from command module 230 to detection module 220). As yet another example, command module 230 may provide recordings (e.g., animal calls), such that detection module 220 can perform statistical comparisons to determine if a wildlife object is present (e.g., based upon correlation with sensor data above a pre-determined threshold). Accordingly, detection module 220 may then record instances of the desired wildlife objects according to the instructions set by command module 230.

In some embodiments, detection module 220 may be pre-configured to record certain wildlife objects without requiring any instructions from command module 230. For instance, detection module 220 may already be configured to detect artificial boundaries such as vehicle barriers that affect vehicle operation, even if they may also be recorded as wildlife objects.

When wildlife related objects are recorded to sensor data 250, command module 230 may analyze such wildlife related objects to determine if it should update an animal record or habitat record. For example, sensor data 250 may contain wildlife object data relating to substantial impacts on habitat properties (e.g., crops are no longer present, meadow has been flooded) such that command module 230 updates the relevant habitat record to reflect such impacts. As another example, sensor data 250 may contain wildlife object data describing a current transitory state of the habitat (e.g., it is raining/sunny/cloudy/windy, there are loud noises from construction or aircraft, temperatures near or in the habitat) such that command module 230 updates any relevant habitat record to reflect such transitory states. Similarly, the sensor data 250 may contain wildlife object data regarding the detection of animals or indications of animal behavior such that command module 230 updates any relevant animal record to reflect such information. In some embodiments, command module 230 may share wildlife objects with other vehicles or with servers in cloud-computing environment 300, such as where animal records or habitat records indicate that such sharing should occur. In this manner, vehicle 100 may share wildlife objects with other vehicles such that the other vehicles can analyze the wildlife objects independently of any analysis performed by vehicle 100.

In some embodiments, command module 230 may receive habitat records that define geographical areas surrounding vehicle 100. In some embodiments, command module 230 may generate habitat records that define geographical areas surrounding vehicle 100. For example, general habitat records may define general characteristics, boundary conditions, and other factors that define a habitat type, which command module 230 then applies to sensor data 250 to determine where specific habitats of such a habitat type begin or end geographically. After determining where specific habitats of a habitat type begin or end geographically, command module 230 may send such specific habitat records via a wildlife database update request (e.g., to a global wildlife database, nearby vehicles, etc.). In this manner, vehicles traveling within an area may obtain a common set of habitat records covering such an area, such as from vehicle 100 or a global wildlife database. In some embodiments, habitat records may overlap geographically, such as where different animals coexist within their own separate but overlapping habitat areas (e.g., habitat records for birds may geographically overlap with habitat records for ground mammals).

Command module 230 may use models or statistical measures to predict the behavior of animals based on sensor data 250, including but not limited to wildlife object data. Such models or statistical measures may be stored in animal records or habitat records. For example, based on the presence of particular types of food, cover, and water detected within a habitat, command module 230 may use a model or statistical measures to determine the likely presence of various animals (e.g., based on models or statistical measures indicating when an animal group is likely to be feeding, resting, or seeking water). As another example, if an animal is observed near vehicle 100, command module 230 may use models or statistical measures, such as dispersal and density models or statistical measures, to determine the likelihood of similar animals being near the observed animal.

In general, animal records and habitat records may contain considerable information about how a specific group of animals may behave within a habitat based on current or changing conditions. For example, animal records or habitat records may contain information regarding migratory behavior, including models or statistical measures indicating when and where migration by an animal group may occur. In addition, when such information is not available, command module 230 may act to generate such information. For example, command module 230 may analyze sensor data 250 to determine seasonal variations of animals with respect to geographically defined habitat records (e.g., animals are only present in mountainous habitat records during summer). Once such seasonal variations are detected, command module 230 may evaluate wildlife object data to determine when such variations are likely to occur and also what routes they took. For example, if wildlife object data occurs that animals transited through a habitat zone during a specific period (e.g., April to May), command module 230 may then use wildlife object data to determine migration routes through the habitat zone (e.g., based on where the animal was detected, based on indications of animal presence/behavior that were detected such as animal tracks).

In some embodiments, if any desired wildlife object data is not available, command module 230 may send a wildlife database collection request specifying the desired wildlife object data for one or more animal records or one or more habitat records to be obtained by any vehicle or other source that is capable of obtained such wildlife object data. In some embodiments, the wildlife database collection request may also include instructions for performing analysis on the wildlife object data. In some embodiments, the wildlife database collection request may be stored within animal record(s), habitat record(s), or both, such that wildlife database collection request is transmitted when record(s) it is stored in are retrieved (e.g., based on a wildlife database geographic-based request 700).

Command module 230 based on wildlife object data or other factors may also determine a likelihood of a wildlife-vehicle collision. For example, based on analysis of habitat records on both sides of the rode, command module 230 may determine that it is likely that particular animals (e.g., deer) will cross over the road around sunset (e.g., the deer move from a habitat with food to one with cover across the road). As another example, vehicle 100 may receive notification of the actual presence of an animal at a particular time (e.g., from another vehicle ahead of vehicle 100), which may cause command module 230 to estimate one or more likely routes the animal may have taken and if any such routes pose a risk of a wildlife-vehicle collision.

A determination of a likelihood of a wildlife-vehicle collision by command module 230 is not necessarily limited to only a potential collision with vehicle 100, but rather may also be determined based on the location, heading, direction, etc. of vehicle 100, other vehicles, the possibility of vehicles travelling within an area, etc. (e.g., by using sensor data 250, including any wildlife object data, to make such determinations). For example, vehicle 100 may traveling with another vehicle nearby on a route where animal presence is likely, as such command module 230 may determine a likelihood of a wildlife-vehicle collision for vehicle 100, the nearby vehicle (whose direction and heading may be obtained from sensor data 250), and for any future vehicle coming toward vehicle 100's location (e.g., for the next 15 minutes based on where such a vehicle may likely transit).

If the likelihood of a wildlife-vehicle collision is determined by command module 230 to be above a pre-determined threshold (e.g., as specified by an animal record or habitat record for a particular animal), command module 230 may engage in or recommend risk reduction strategies. A risk reduction strategy may encompass any action by vehicle 100 that can reduce the likelihood of a wildlife-vehicle collision. In some embodiments, animal records or habitat records may provide a selection of possible risk reduction strategies for command module 230 to evaluate based on the available sensor data. Examples of risk reduction strategies may include limiting vehicle speed, rerouting/detours, engaging animal deterrence strategies (e.g., sirens, flashing lights, odor emitters, predator calls), platooning or other coordinated multi-vehicle maneuvers, activating pre-stiffening functions, and so on.

Command module 230 may then select a risk reduction strategy based on, for example, an estimated probability of success. As another example, command module 230 may select a risk reduction strategy based on priority, such that higher priority risk reduction strategies may be exercised first, which then may be followed by the next lower priority risk reduction strategy if the highest priority risk reduction strategy does not succeed. In some embodiments, command module 230 may instruct vehicle 100 to perform a risk reduction strategy. In some embodiments, command module 230 may instruct another vehicle to perform a risk reduction strategy. In some embodiments, command module 230 may specify a geographic area (e.g., within an animal record or habitat record), in which vehicles entering such a geographic area are instructed to perform a risk reduction strategy, which may then be transmitted to other vehicles, cloud-computing environment 300, etc. In some embodiments, such a geographically defined risk reduction strategy may be stored within an animal record or a habitat record.

In some embodiments, command module 230 may evaluate whether the risk reduction strategy was effective. For example, command module 230 may utilize outcomes such as whether a wildlife-vehicle collision was avoided, whether an animal rapidly moved away from a vehicle or changed heading, and so on to evaluate the effectiveness of a risk reduction strategy. Based on command module 230's evaluation of the effectiveness of a risk reduction strategy, command module 230 may adjust an estimated probability of success or priority associated with the risk reduction strategy. In some embodiments, command module 230 may utilize machine learning to evaluate the effectiveness of a risk reduction strategy.

Command module 230 based on wildlife object data or other factors may also determine a likelihood of a wildlife-safety hazard. A wildlife-safety hazard is any event which may cause harm to an animal, a person, or property due to the presence of the animal in conjunction with people, vehicle 100, other vehicles, other factors, or a combination thereof. For example, sensor data 250 may show the presence of a bear within a habitat, which may be of potential harm to nearby pedestrians, cyclists, etc. As another example, sensor data 250 may show that deer are feeding on crops or wildflowers, which may be of post a risk of significant economic or environmental harm. As yet another example, sensor data 250 may show that a group of animals is unable to cross a road as they would normally be expected to due to heavy vehicle traffic, thereby denying them access to the safety of their preferred cover. Methods, models, or other approaches for determining the likelihood of a wildlife-safety hazard may be stored in an animal record or a habitat record, including any criteria by which the likelihood of a wildlife-safety hazard should be measured.

A determination of a likelihood of a wildlife-safety hazard by command module 230 is not necessarily limited to only vehicle 100, but rather may also be determined based on information relating to vehicle 100, other vehicles, the presence of people (e.g., pedestrians, cyclists), property nearby, etc. (e.g., by using sensor data 250, including any wildlife object data, to make such determinations). For example, if vehicle 100 detects animal sounds indicating the possible presence of a dangerous predator, command module 230 may determine a likelihood of a wildlife-safety hazard to pedestrians or cyclists within a geographical area (e.g., within 2 miles of vehicle 100).

If the likelihood of a wildlife-safety hazard is determined by command module 230 to be present, such as by finding the likelihood to be above a pre-determined threshold (e.g., as specified by an animal record or habitat record for a particular animal), command module 230 may engage in or recommend safety enhancement strategies. A safety enhancement strategy may encompass any action by vehicle 100, other vehicles, or the use of available services (e.g., as provided by cloud-computing environment 300) that can reduce the likelihood of a wildlife-safety hazard or the potential for harm associated with the wildlife-safety hazard. In some embodiments, animal records or habitat records may provide a selection of possible safety enhancement strategies for command module 230 to evaluate based on the available sensor data.

Examples of safety enhancement strategies may include specifying individual or cooperative vehicle maneuvers to deter animals, engaging animal deterrence strategies (e.g., sirens, flashing lights, odor emitters, predator calls), notifying others of the presence of a wildlife-safety hazard, and so on. For example, where a dangerous predator is determined to present a wildlife-safety hazard, command module 230 may send electronic messages to third parties identifying the threat (e.g., notifying emergency services) or specify an instruction that vehicle 100 or other vehicles near the hazard should, if any pedestrian or cyclist is encountered, slow down and deliver a visual or audio warning to the pedestrian or cyclist.

Command module 230 may then select a safety enhancement strategy based on, for example, an estimated probability of success. As another example, command module 230 may select a safety enhancement strategy based on priority, such that higher priority safety enhancement strategies may be exercised first, which then may be followed by the next lower priority safety enhancement strategy if the highest priority safety enhancement strategy does not succeed. In some embodiments, command module 230 may instruct vehicle 100 to perform a safety enhancement strategy. In some embodiments, command module 230 may instruct another vehicle to perform a safety enhancement strategy. In some embodiments, command module 230 may specify a geographic area (e.g., within an animal record or habitat record), in which vehicles entering such a geographic area are instructed to perform a safety enhancement strategy, which may then be transmitted to other vehicles, cloud-computing environment 300, etc. In some embodiments, such a geographically defined safety enhancement strategy may be stored within an animal record or a habitat record.

In some embodiments, command module 230 may evaluate whether the safety enhancement strategy was effective. For example, command module 230 may utilize outcomes such as whether a wildlife-safety hazard was avoided, the extent of harm that may have occurred, and so on to evaluate the effectiveness of a safety enhancement strategy. Based on command module 230's evaluation of the effectiveness of a safety enhancement strategy, command module 230 may adjust an estimated probability of success or priority associated with the safety enhancement strategy. In some embodiments, command module 230 may utilize machine learning to evaluate the effectiveness of a safety enhancement strategy.

In some embodiments, an animal record, habitat record, or user settings within vehicle 100 may restrict command module 230 from selecting or performing a risk reduction strategy or a safety enhancement strategy (or a portion thereof). For example, certain strategies that may work for some animals may nonetheless be harmful to other animals, such that the use of such strategies is restricted where animals that would be harmed are present or likely to be present.

In some embodiments, command module 230 may be instructed to help with locating an animal. For example, an animal record or habitat record may contain an instruction for command module 230 to report any detection of an animal or information indicating the likelihood of its presence (e.g., due to animal sounds, tracks, droppings, etc.). In this manner, an ornithologist for instance may use the system to track down where a particular bird of interest is available for study.

While the above examples are generally directed toward monitoring and managing the presence of wildlife, it should be understood that the systems and methods described herein may also be capable of monitoring and managing the presence of domestic animals. As such, the likelihood of wildlife-vehicle collisions, the likelihood of wildlife-safety hazards, risk reduction strategies, safety enhancement strategies, or any other aspects of the systems and methods described herein may also be provided with respect to domestic animals.

FIG. 8 illustrates a flowchart of a method 800 that is associated with using wildlife monitoring and management strategies. Method 800 will be discussed from the perspective of the wildlife management system 170 of FIGS. 1 and 2. While method 800 is discussed in combination with the wildlife management system 170, it should be appreciated that the method 800 is not limited to being implemented within wildlife management system 170 but is instead one example of a system that may implement method 800.

At step 810, command module 230 may receive wildlife records identifying an animal and a habitat. For example, vehicle 100 may have received a selection of a planned route of travel via a navigation interface. Based on the planned route, command module 230 may select a geographic area encompassing the route (e.g., points along the route, any area within 25 ft of the route), which may then be sent to a global wildlife database with a request for any wildlife records within the selected geographic area. Upon receiving the request, the global wildlife database may search for and then send any relevant wildlife records that are found. Upon receiving the requested wildlife records, vehicle 100 may then store them in a localized wildlife database.

At step 820, command module 230 may detect wildlife objects relating to the animal within an area defined by the habitat. For example, command module 230 may use wildlife records to initialize detection module 220 (e.g., so it can detect wildlife objects). Examples of wildlife objects can include for example, the recognition of types of food, cover, or water that is preferred by animal as well as sounds or odors emitted by an animal.

At step 830, command module 230 may determine a likelihood of a wildlife vehicle collision based on the wildlife objects. For example, wildlife objects showing the presence of a band of shrubbery between a river and road may be associated with cover for deer. A wildlife record associated with deer may also indicate (e.g., by a model, by statistical measures) that at sundown deer are likely to look for water near cover. Based on such a model or statistic measures, command module 230 may evaluate the cover and the current time to determine the probability of deer being present (e.g., high risk at sundown, low risk at night).

At step 840, command module 230 may select a risk reduction strategy if the likelihood of the wildlife vehicle collision is determined to be above a threshold. For example, command module 230 may instruct vehicle 100 via a risk reduction strategy to limit its speed near an area that has been determined to be at high risk for a collision with a deer.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, wildlife management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, wildlife management system 170, automated driving module(s) 160, or any combination thereof may control some or all of these vehicle system(s) 140 and, thus, may be partially or fully autonomous.

Processor(s) 110, wildlife management system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, wildlife management system 170, automated driving module(s) 160, or any combination thereof may control the direction, speed, or both of vehicle 100. Processor(s) 110, wildlife management system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with wildlife management system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
receive wildlife records identifying an animal and a habitat;
detect wildlife objects relating to the animal within an area defined by the habitat;
determine a likelihood of a wildlife vehicle collision based on the wildlife objects; and
select a risk reduction strategy if the likelihood of the wildlife vehicle collision is determined to be above a threshold.

2. The system of claim 1, wherein the machine-readable instructions that, when executed by the processor, further includes causing the processor to:
define a geographical area; and
request any wildlife records relating to the geographical area.

3. The system of claim 1, wherein the machine-readable instructions to determine wildlife objects includes a capability of recognizing food, cover, or water as wildlife objects associated with the animal.

4. The system of claim 1, wherein the machine-readable instructions to determine wildlife objects includes a capability of recognizing sounds or odors as wildlife objects associated with the animal.

5. The system of claim 1, wherein the machine-readable instructions to determine the likelihood of the wildlife vehicle collision based on the wildlife objects includes applying a model of the animal to determine a route of the animal.

6. The system of claim 5, wherein the machine-readable instructions to determine the likelihood of the wildlife vehicle collision based on the wildlife objects includes determining whether wildlife objects associated with the animal indicates a possible encounter with a second animal.

7. The system of claim 1, wherein the machine-readable instructions that, when executed by the processor, further includes causing the processor to:
perform an evaluation of a result of the risk reduction strategy; and
adjust a preference for the risk reduction strategy based on the evaluation.

8. A non-transitory computer-readable medium including instructions that when executed by one or more processors cause the one or more processors to:
receive wildlife records identifying an animal and a habitat;
detect wildlife objects relating to the animal within an area defined by the habitat;
determine a likelihood of a wildlife vehicle collision based on the wildlife objects; and
select a risk reduction strategy if the likelihood of the wildlife vehicle collision is determined to be above a threshold.

9. The non-transitory computer-readable medium of claim 8, wherein the instructions further include to:
define a geographical area; and
request any wildlife records relating to the geographical area.

10. The non-transitory computer-readable medium of claim 8, wherein the instructions to determine wildlife objects includes a capability of recognizing food, cover, or water as wildlife objects associated with the animal.

11. The non-transitory computer-readable medium of claim 8, wherein the instructions further include to determine wildlife objects includes a capability of recognizing sounds or odors as wildlife objects associated with the animal.

12. The non-transitory computer-readable medium of claim 8, wherein the instructions further include to determine the likelihood of the wildlife vehicle collision based on the wildlife objects includes applying a model of the animal to determine a route of the animal.

13. The non-transitory computer-readable medium of claim 12, wherein the instructions further include to determine the likelihood of the wildlife vehicle collision based on the wildlife objects includes determining whether wildlife objects associated with the animal indicates a possible encounter with a second animal.

14. A method, comprising:
receiving wildlife records identifying an animal and a habitat;
detecting wildlife objects relating to the animal within an area defined by the habitat;
determining a likelihood of a wildlife vehicle collision based on the wildlife objects; and
selecting a risk reduction strategy if the likelihood of the wildlife vehicle collision is determined to be above a threshold.

15. The method of claim 14, further comprising:
defining a geographical area; and
requesting any wildlife records relating to the geographical area.

16. The method of claim 14, wherein determining wildlife objects includes a capability of recognizing food, cover, or water as wildlife objects associated with the animal.

17. The method of claim 14, wherein determining wildlife objects includes a capability of recognizing sounds or odors as wildlife objects associated with the animal.

18. The method of claim 14, wherein determining the likelihood of the wildlife vehicle collision based on the wildlife objects includes applying a model of the animal to determine a route of the animal.

19. The method of claim 18, wherein determining the likelihood of the wildlife vehicle collision based on the wildlife objects includes determining whether wildlife objects associated with the animal indicates a possible encounter with a second animal.

20. The method of claim 14, further comprising:
performing an evaluation of a result of the risk reduction strategy; and
adjusting a preference for the risk reduction strategy based on the evaluation.
